(19) United States
(12) Patent Application Publication
(10) Pub. No.: US 2015/0023527 A1
(43) Pub. Date: Jan. 22, 2015

(54) ELECTRONIC APPARATUS

(71) Applicant: KYOCERA CORPORATION, Kyoto (JP)

(72) Inventor: Takafumi Sato, Yokohama-shi (JP)

(73) Assignee: KYOCERA CORPORATION, Kyoto (JP)

(21) Appl. No.: 14/378,488

(22) PCT Filed: May 15, 2013
(86) PCT No.: PCT/JP2013/003089

§ 371 Date: Aug. 13, 2014

(30) Foreign Application Priority Data
May 16, 2012 (JP) 2012-112691

(51) Int. Cl. H04R 17/00; H04R 1/02

(52) U.S. Cl. CPC H04R 17/00; H04R 1/025; H04R 2201/025; H04R 2460/13
USPC 381/151

(57) ABSTRACT

An electronic apparatus that is hermetically sealable without hindering size reduction thereof is provided. An electronic apparatus 1 according to the present invention includes a housing 60 and a panel 10 supported by the housing 60, wherein the panel 10 includes a first joint region attached to the housing 60 by a first joint member 70a as an adhesive.

### CROSS REFERENCE TO RELATED APPLICATION

This application claims priority to and the benefit of Japanese Patent Application No. 2012-112691 (filed on May 16, 2012), the entire contents of which are incorporated herein by reference.

### TECHNICAL FIELD

The present invention relates to an electronic apparatus that vibrates a panel by applying a predetermined electric signal (sound signal) on a piezoelectric element and, by delivering the vibration of the panel to a human body, delivers an air conduction sound and a bone conduction sound to a user.

### BACKGROUND ART

Patent Document 1 describes an electronic apparatus such as a mobile phone terminal that delivers an air conduction sound and a bone conduction sound to a user. Patent Document 1 also describes that the air conduction sound is a sound that is delivered to the auditory nerve of the user when vibration of the air caused by vibration of an object is delivered to the ear dram via the ear canal and the ear dram vibrates. Patent Document 1 further describes that the bone conduction sound is a sound that is delivered to the auditory nerve of the user via a part of a user's body (for example, the cartilage of the ear) in contact with the vibrating object.

Patent Document 1 describes that a vibrator in the shape of a short rectangular plate formed of a piezoelectric bimorph and a flexible material is attached to an outer surface of the housing of the phone via an elastic member. Patent Document 1 also describes that, upon application of a voltage to the piezoelectric bimorph of the vibrator, a piezoelectric material stretches in a longitudinal direction causing bending vibration of the vibrator and, when the user brings the vibrator into contact with the auricle, the air conduction sound and the bone conduction sound are delivered to the user.

### RELATED ART DOCUMENT

### Patent Document

Patent Document 1: Japanese Patent Application Laid-Open Publication No. 2005-348193

### SUMMARY OF INVENTION

### Technical Problem

According to the electronic apparatus described in Patent Document 1, a vibrator is attached to the outer surface of the housing of the mobile phone and the like. Therefore, there is no consideration about a problem when the panel attached to the housing is vibrated.

An object of the present invention is to provide an electronic apparatus that is appropriately usable also as an electronic apparatus that vibrates the panel attached to the housing.

### Solution to Problem

An electronic apparatus according to the present invention includes a housing and a panel supported by the housing, wherein the panel includes a first joint region attached to the housing by a first joint member as an adhesive.

The electronic apparatus may include a piezoelectric element supported by the panel.

The electronic apparatus may include a second joint region where a peripheral portion of a region of the panel supporting the piezoelectric element is attached to the housing by a second joint member having lower hardness than that of the adhesive.

The second joint member may be a double-sided adhesive tape.

A portion of the first joint region and a portion of the second joint region may overlap each other.

An outline of the portion of the first joint region may have an irregular shape in a planar view of the panel.

An outline of the part of the second joint region may have an irregular shape in the planar view.

The outline of the portion of the first joint region may have an irregular shape corresponding to the irregular shape of the second joint region.

The adhesive may have elasticity.

The housing may have a rectangular shape in a planar view with two sides opposite to each other equal to or longer than a distance from the antitragus to the inferior antihelix crus.

The housing may have the other two sides opposite to each other equal to or longer than a distance from the tragus to the antihelix.

The piezoelectric element may be fixed to the housing by a third joint member.

The third joint member may be a non-heat curable adhesive.

The third joint member may be the double-sided adhesive tape.

The panel may constitute any one of, or all of a display unit, an input unit, and a cover of the display unit.

An attaching region of the panel having the piezoelectric element fixed thereto may be located outside a region of the panel overlapping the display unit in a planer view.

The display unit may be fixed to the panel from the inside of the housing.

The panel may generate an air conduction sound.

### Effect of the Invention

The present invention is appropriately applicable also to the electronic apparatus that vibrates the panel attached to the housing.

### BRIEF DESCRIPTION OF DRAWINGS

FIG. 1 is a diagram illustrating a functional block of a main section of an electronic apparatus according to one embodiment of the present invention;

FIG. 2 is a diagram illustrating a suitable shape of a panel;

FIGS. 3(a) to (c) are diagrams schematically illustrating a main section of a housing structure of an electronic apparatus according to a first embodiment;

FIG. 4 is a diagram illustrating an example of vibration of a panel of the electronic apparatus according to the first embodiment;

FIG. 5 is a diagram illustrating an example of an overlapping region of a first joint member and a second joint member of the electronic apparatus according to the first embodiment;

FIG. 6 is a diagram illustrating an example of the overlapping region of the first joint member and the second joint member of the electronic apparatus according to the first embodiment;

FIG. 7 is a diagram illustrating an example of the overlapping region of the first joint member and the second joint member of the electronic apparatus according to the first embodiment;

FIG. 8 is a diagram illustrating an example of the overlapping region of the first joint member and the second joint member of the electronic apparatus according to the first embodiment;

FIGS. 9(a) to (c) are diagrams schematically illustrating a main section of a housing structure of an electronic apparatus according to a second embodiment; and

FIG. 10 is a diagram illustrating an example of vibration of a panel of the electronic apparatus according to the second embodiment.

### DESCRIPTION OF EMBODIMENTS

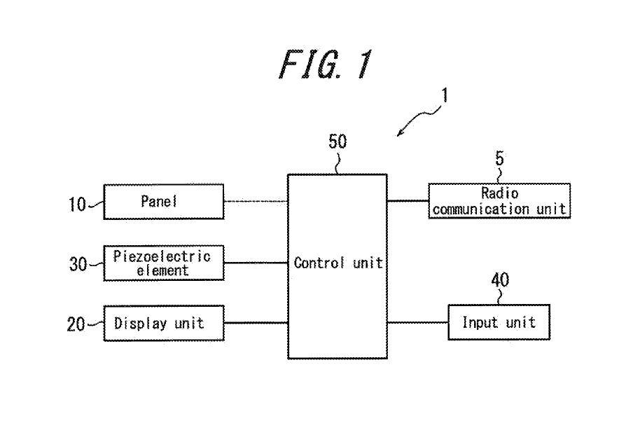

Hereinafter, embodiments of the present invention will be described in detail with reference to the accompanying drawings. FIG. 1 is a diagram illustrating a functional block of a main section of an electronic apparatus 1 according to one embodiment of the present invention. The electronic apparatus 1 is a mobile phone terminal, for example, and includes a radio communication unit 5, a panel 10, a display unit 20, a piezoelectric element 30, an input unit 40, and a control unit 50. The radio communication terminal 5 has a known configuration and is wirelessly connected to a communication network via a base station and the like.

The panel 10 is a touch panel for detecting a contact, or a cover panel and the like for protecting the display unit 20. The panel 10 is formed of, for example, glass or synthetic resin such as acrylic and the like. The panel 10 preferably has a plate-like shape. The panel 10 may be a flat plate or a curved panel with smoothly inclined surface. The panel 10 as the touch panel detects a contact by a user's finger, a pen, a stylus pen and the like. A detection method of the touch panel may be any one of an electrostatic capacitance method, a resistance film method, a surface acoustic wave method (or an ultrasound method), an infrared method, an electromagnetic induction method, a load detection method and the like.

The display unit 20 is a display device such as a liquid crystal display, an organic EL display, an inorganic EL display and the like. The display unit 20 is disposed on a rear side of the panel 10. For example, the display unit 20 is disposed on a rear surface of the panel 10 by a joint member (for example, an adhesive). Or, the display unit 20 may be adhered to the panel 10 by the joint member (for example, the adhesive) and supported by a housing of the electronic apparatus 1 while being spaced apart from the panel 10.

The piezoelectric element 30 is an element that, upon application of an electric signal (a voltage), stretches or curves (bends) in accordance with an electromechanical coupling coefficient of a material constituting the piezoelectric element. The piezoelectric element may be formed of, for example, ceramic or crystal. The piezoelectric element 30 may be a unimorph, a bimorph, or a laminated-type piezoelectric element. The laminated-type piezoelectric element includes a laminated unimorph element including laminated unimorphs (for example, 16 to 24 layers), or a laminated bimorph element including laminated bimorphs (for example, 16 to 24 layers). The laminated-type piezoelectric element has a multilayer structure including a plurality of dielectric layers formed of, for example, PZT (lead zirconate titanate) and electrode layers disposed therebetween. The unimorph stretches upon application of the electric signal (voltage), while the bimorph curves upon application of the electric signal (voltage).

The piezoelectric element 30 is disposed on the rear surface of the panel 10 (on a plane inside the electronic apparatus 1). The piezoelectric element 30 is attached to the panel 10 by a joint member (for example, a double-sided adhesive tape). The piezoelectric element 30 may be attached to the panel 10 via an intermediate member (for example, sheet metal). The piezoelectric element 30 is disposed on the rear surface of the panel 10 and spaced apart by a predetermined distance from the surface inside the housing. The piezoelectric element 30 is preferably spaced apart from the surface inside the housing by the predetermined distance also when stretching or curving. That is, a distance between the piezoelectric element 30 and the surface inside the housing is preferably greater than a maximum deformation amount of the piezoelectric element 30.

The input unit 40 receives an input operation from a user and is constituted by using, for example, an operation button (an operation key). When the panel 10 is the touch panel, the panel 10 may also receive the input operation from the user by detecting the contact by the user.

The control unit 50 is a processor for controlling the electronic apparatus 1. The control unit 50 applies a predetermined electric signal (a voltage corresponding to an acoustic signal of an opposite party, a ring tone or music including songs) to the piezoelectric element 30. The acoustic signal may be based on music data stored in an internal memory or music data stored in an external server and the like to be replayed via the network.

When the electric signal is applied to the piezoelectric element 30, the piezoelectric element 30 stretches or bends in a longitudinal direction thereof. At this time, the panel 10 having the piezoelectric element 30 attached thereto deforms following the stretch or bend of the piezoelectric element 30 and vibrates in a curved manner. Here, a maximum voltage of the electric signal applied to the piezoelectric element 30 by the control unit 50 may be ±15 V, for example, which is higher than a voltage applied by what is called a panel speaker used for the purpose of delivering sound by an air conduction sound as opposed to a vibration sound. Accordingly, when the user presses the panel 10 against a user's body applying the force of, for example, 3 N or more (the force of 5 N to 10 N), the panel 10 may sufficiently vibrate in the curved manner and generate the vibration sound via a part of the user's body (for example, the cartilage of the ear). Note that a level of the voltage to apply is appropriately adjustable depending on fixing strength of the panel 10 to the housing or the support member, or depending on performance of the piezoelectric element 30. The panel 10 curves by the stretch or curve of the piezoelectric element 30. The panel 10 is directly bent by the piezoelectric element 30. Note that “the panel 10 is directly bent by the piezoelectric element” is different from a phenomenon that, as employed by a conventional panel speaker, an inertial force of a piezoelectric actuator composed of the piezoelectric element disposed inside a casing excites a specific region of the panel and deforms the panel. “The panel 10 is directly bent by the piezoelectric element” means that the stretch or curve (bend) of the piezoelectric element directly bends the panel via the joint member, or via the joint member and a reinforcing member 100 described below.

The panel 10 vibrates in the curved manner in an attaching region having the piezoelectric element 30 attached thereto, as well as in a region remote from the attaching region. The panel 10, in the region to vibrate, includes a plurality of portions that vibrate in a direction intersecting with a main surface of the panel 10, in each of which a value of amplitude of the vibration changes from negative to positive or vice versa with time. The panel 10, at a certain moment, vibrates in such a manner that regions with relatively large vibration amplitude and regions relatively small vibration amplitude are seemingly distributed randomly or periodically in a substantially entire panel 10. That is, over the entire panel 10, vibrations of a plurality of waves are detected. In order to prevent attenuation of the vibration of the panel 10 described above when the user presses the panel 10 against the user's body applying the force of, for example, 5 N to 10 N, the maximum voltage applied to the piezoelectric element 30 by the control unit 50 may be ±15 V. Thereby, the user may hear the sound by bringing the region remote from the attaching region of the piezoelectric element 30 described above such as, for example, a center portion of the panel 10 into contact with the ear.

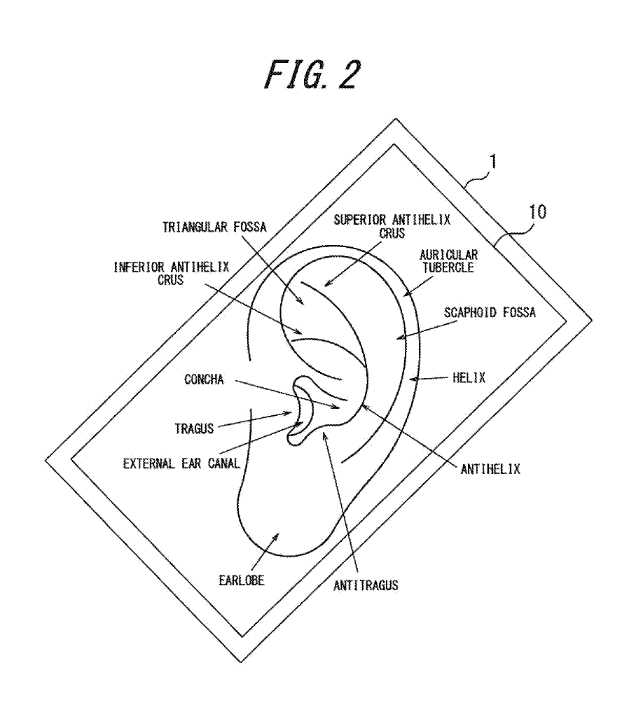

Here, the panel 10 may be in size approximately similar to the user's ear. Or, as illustrated in FIG. 2, the panel 10 may be larger than the user's ear. In this case, when the user listens to the sound, since the entire ear is likely to be covered by the panel 10 of the electronic apparatus 1, less surrounding sounds (noises) may enter the ear canal. The panel 10 (or the housings 60, 60a described below) needs to vibrate in a region larger than a region having a length corresponding to a distance from the inferior antihelix crus (the lower antihelix crus) to the antitragus and a width corresponding to a distance from the tragus and the antihelix. Preferably, the panel 10 vibrates in a region having a length corresponding to a distance from an area near the superior antihelix crus (the upper antihelix crus) of the helix to the lobe and a width corresponding to a distance from the tragus to an area near the antihelix of the helix. The region having the length and width described above may be in a rectangular shape, or in an oval shape having the above length as a long diameter and the above width as a short diameter. An average ear size of Japanese people may be obtained from Database of Japanese Body Size (1992-1994) provided by Research Institute of Human Engineering for Quality Life (HQL). When the panel 10 is equal to or larger than the average ear size of Japanese people, it is considered that the panel 10 may cover most of foreign nationals' entire ears. Having the sizes and the shapes described above, the panel 10 may cover the user's ear and have an allowance for misalignment thereof relative to the ear.

The electronic apparatus 1 described above, by vibrating the panel 10, may deliver the air conduction sound and the vibration sound through a part of the user's body (for example, the cartilage of the outer ear). Therefore, when sound at a volume similar to that of a conventional dynamic receiver is output, less sound is transmitted around the electronic apparatus 1 through air vibration by the vibration of the panel 10 as compared with that of the dynamic receiver. Accordingly, the electronic apparatus 1 is suitable for listening to, for example, a recorded message on a train or the like.

Also, the electronic apparatus 1 described above delivers the vibration sound by vibrating the panel 10. Therefore, when the user is wearing, for example, earphones or headphones, the user may hear the sound via the earphones or the headphones and a part of the user's body by bringing the electronic apparatus 1 into contact with the earphones or the headphones.

The electronic apparatus 1 described above delivers the sound to the user by vibrating the panel 10. Therefore, when the electronic apparatus 1 does not separately have the dynamic receiver, an opening (a sound opening) for voice transmission does not need to be formed on the housing, which allows simplification of a waterproof structure of the electronic apparatus 1. When the electronic apparatus 1 has the dynamic receiver, the sound opening is preferably sealed with a material that ventilates while blocking liquid. Such a material for ventilating while blocking liquid is, for example, Gore-Tex (registered trademark).

### First Embodiment

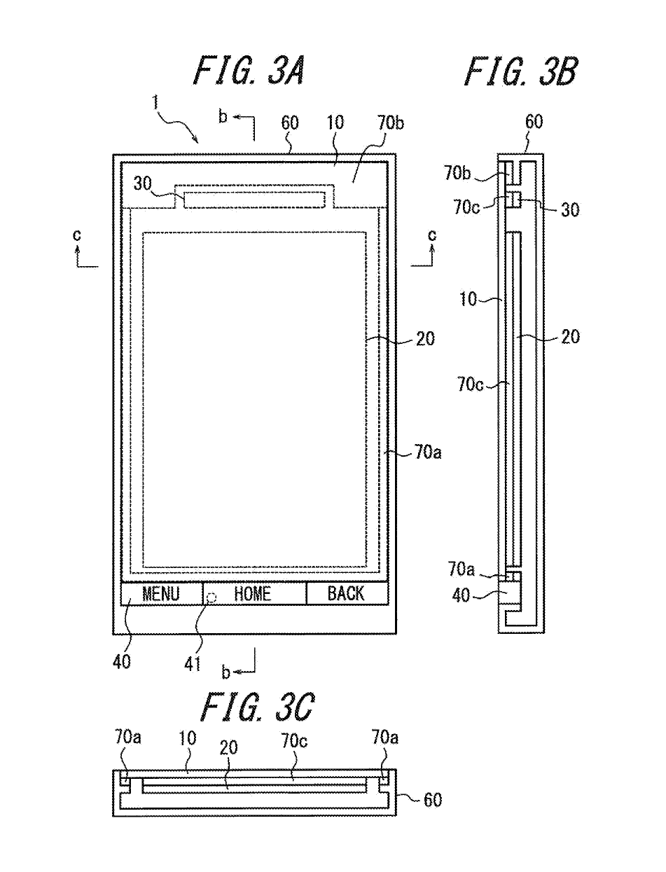

FIG. 3 are diagrams schematically illustrating a main section of a housing structure of the electronic apparatus 1 according to a first embodiment. FIG. 3(a) is a front view, and FIG. 3(b) is a cross-sectional view taken from line b-b of FIG. 3(a). FIG. 3(c) is a cross-sectional view taken from line c-c of FIG. 3(a). The electronic apparatus 1 illustrated in FIG. 3 is a smart phone having a glass plate in a substantially rectangular shape in a planar view serving as the panel 10 disposed on a front face of a housing 60 (for example, a metallic or resin case).

The panel 10 constitutes, for example, the touch panel of the electrostatic capacitance method and, in a first joint region, is supported (held) by the housing 60 via a joint member (first joint member) 70a. Also, the panel 10, in a second joint region, is supported by the housing 60 via a joint member (second joint member) 70b. Accordingly, the electronic apparatus 1, in order to join the panel 10 and the housing 60 together, includes the first joint region and the second joint region.

The panel 10 includes an upper rear surface on one side in a longitudinal direction, which is one direction in the planar view, having the piezoelectric element 30 attached thereto via a joint member (a third joint member) 70c, thereby supporting piezoelectric element 30. That is, as illustrated in FIG. 3(a), a fixed portion of the piezoelectric element 30 locates outside an overlapping region of the panel 10 and the display unit 20 in a planar view. Also, the piezoelectric element 30 is fixed to the housing 60 by the joint member 70c via the panel 10. The piezoelectric element 30 has a substantially rectangular shape in the planar view and is attached in such a manner that a long side thereof comes along a short side of the panel 10. Also, the panel 10 has the rear surface to which, except the upper area of the one side in the longitudinal direction, the display unit 20 is attached via the joint member 70c. That is, the display unit 20 is fixed to the panel 10 by the joint member 70c.

The joint member 70a is a liquid adhesive or a liquid-like fluid adhesive and may be, for example, a thermocurable adhesive, an ultraviolet curable adhesive (e.g., acrylic ultraviolet curable adhesive) and the like.

Or, the joint member 70a may be an adhesive obtaining elasticity after curing, such as an adhesive containing a modified silicone resin. Such an adhesive obtains a rubber elasticity after curing and thus capable of absorbing an impact when the electronic apparatus 1 is subjected to impact due to dropping and the like. The absorption of the impact may prevent from damaging the electronic apparatus 1 and removing the panel 10 from the housing 60.

The joint member 70b has lower hardness than that of the joint member 70a after curing and may be, for example, the double-sided adhesive tape having a bubble-containing spongy base material. That is, the joint member 70b deforms easier than the joint member 70a. The region (second joint region) where the joint member 70b is used is a peripheral portion of the panel 10 that supports the piezoelectric element 30 (a region of the panel 10 having the piezoelectric element 30 attached thereto). The peripheral portion is a region where the vibration of the piezoelectric element 30 is easily delivered. In FIG. 3(a), the peripheral portion is adjacent to an upper side of the piezoelectric element 30 and closest to the piezoelectric element 30 among four sides forming the panel 10. Note that the peripheral portion does not strictly mean a region surrounding an entire periphery of the piezoelectric element 30 but, as illustrated in FIG. 3(a), may mean a vicinity region of some of sides (three sides) of the piezoelectric element 30.

The joint member 70c for joining the display unit 20 and the piezoelectric element 30 to the panel 10 may be a thermoplastic adhesive, the ultraviolet curable adhesive, the double-sided adhesive tape and the like and may be, for example, an optical elasticity resin which is a colorless and transparent acrylic ultraviolet curable adhesive. Note that, in accordance with the member to be adhered, the joint member 70c of a different material may be appropriately used.

The input unit 40 is supported on the housing 60 on the other side in the longitudinal direction of the panel 10. Also, the input unit 40, as indicated by a broken line, has a mouthpiece 41 of a microphone formed thereon. That is, the housing 60 in the substantially rectangular shape includes an upper portion of one end where the piezoelectric element 30 is disposed and a lower portion of the other end where the mouthpiece 41 is formed.

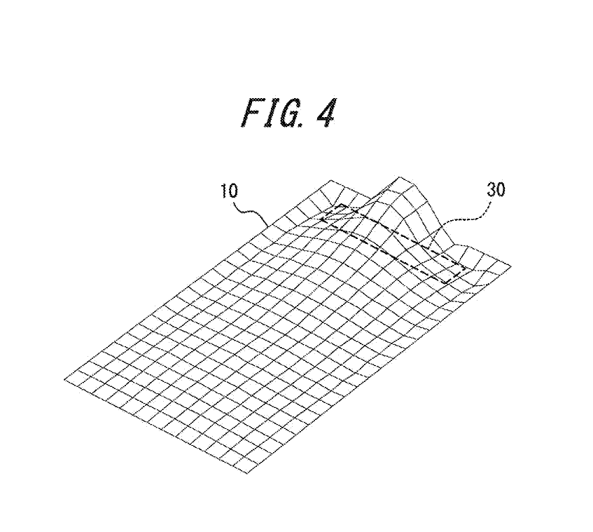

FIG. 4 is a diagram illustrating an example of the vibration of the panel 10 of the electronic apparatus 1 according to the first embodiment. In the electronic apparatus 1 according to the first embodiment, the display unit 20 is attached to the panel 10. Therefore, the other end of the panel 10 less vibrates than the upper portion of the one end of the panel 10 having the piezoelectric element 30 attached to. Accordingly, sound leakage caused by the vibration of the panel 10 at the other end may be reduced. One end of the panel 10 is bent directly by the piezoelectric element 30 and the vibration attenuates at the other end as compared with the one end. The panel 10 is bent by the piezoelectric element 30 in such a manner that a region immediately above the piezoelectric element 30 in the longitudinal direction thereof rises the most as compared with its surroundings.

Next, a boundary between the joint member 70a and the joint member 70b will be described with reference to FIGS. 5 to 8. In FIG. 3(a), at two corners of the one end (upper side) of the panel 10, the boundary between the joint member 70a and the joint member 70b locates. FIGS. 5 to 8 are enlarged views of a peripheral region of one of the two corners.

In FIG. 5, a portion of the first joint region of the joint member 70a and a portion of the second joint region of the joint member 70b overlap each other, forming an overlapping region 80a. Since the joint member 70b is fixed to the housing 60 by the joint member 70a, the joint member 70b is less likely to be removed from the housing 60. When the electronic apparatus 1 is subjected to impact due to dropping and the like, the corners of the electronic apparatus 1 is subjected to strong force. Thus, the overlapping of the joint member 70a and the joint member 70b at the four corners of the housing 60 is effective from the viewpoint of increasing joint strength between the panel 10 and the housing 60.

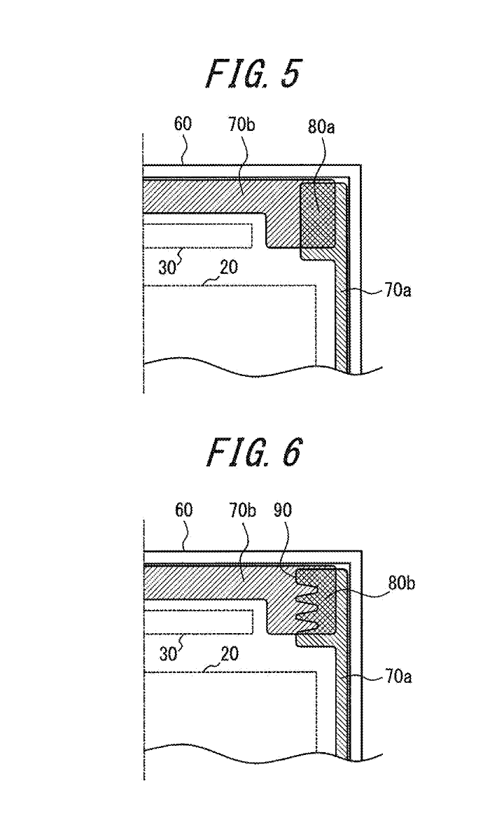

In FIG. 6, a portion of the first joint region of the joint member 70a and a portion of the second joint region of the joint member 70b together form an overlapping region 80b in which an outline of the first joint region has an irregular shape 90 in the planar view of the panel 10. That is, the outline of the first joint region is meandering. The irregular shape 90 makes a contact length of the first joint region in contact with the second joint region longer. The increase in the contact length allows improvement in the joint strength between the panel 10 and the housing 60.

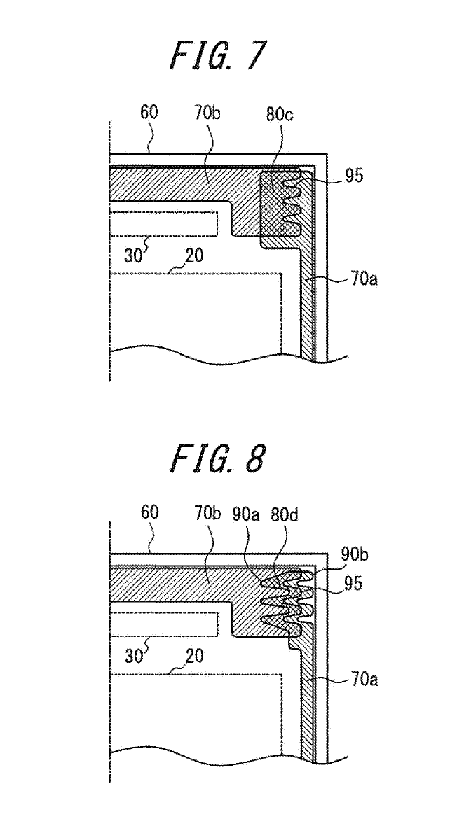

In FIG. 7, a portion of the first joint region of the joint member 70a and a portion of the second joint region of the joint member 70b together form an overlapping region 80c in which an outline of the second joint region has an irregular shape 95 in the planar view of the panel 10. That is, the outline of the second joint region is meandering. The irregular shape 95 makes a contact length of the second joint region in contact with the first joint region longer. The increase in the contacting length allows improvement in the joint strength between the panel 10 and the housing 60.

In FIG. 8, a portion of the first joint region of the joint member 70a and a portion of the second joint region of the joint member 70b together form an overlapping region 80d in which the outline of the second joint region has the irregular shape 95 and the outline of the first joint region includes the irregular shapes 90a, 90b corresponding to the irregular shape 95. The irregular shape of the first joint region corresponding to the irregular shape of the second joint region means that positions of a concave portion and a convex portion of the first joint region meet a concave portion and a convex portion of the second joint region, respectively. Thereby, as illustrated in FIG. 8, the contact length may be increased while amounts of the materials of the joint members 70a, 70b may be reduced. Note that the first joint region may have only one of the irregular shape 90a and the irregular shape 90b corresponding to the irregular shape 95 of the second joint region.

According to the electronic apparatus 1 of the present embodiment, as described above, the panel 10 deforms due to the deformation of the piezoelectric element 30 attached to the rear surface of the panel 10, and sufficiently vibrates from one end in the longitudinal direction, to which the piezoelectric element 30 is attached, to the vicinity of the center portion. Therefore, the user, by bringing at least a part of the region from the center portion of the panel 10 to the upper region into contact with a part of the body (for example, the cartilage of the ear), may hear the air conduction sound and the vibration sound generated by the vibration of the panel 10. Accordingly, the air conduction sound and the vibration sound may be delivered to the user without the necessity to protrude the vibrator on an outer surface of the housing 60, and thus usability is improved better than an electronic apparatus described in Patent Document 1 that requires a vibrator much smaller than a housing be in contact with the human body. Also, since there is no need to bring the piezoelectric element itself into contact with the user's ear, the piezoelectric element 30 is unlikely to be damaged. Further, although deformation of the housing 60 in place of the panel 10 is likely to cause the user to drop the terminal upon generation of the vibration, the vibration of the panel 10 is less likely to cause such an accident.

According to the present embodiment, also, the display unit 20 and the piezoelectric element 30 are attached to the panel 10 by the joint member 70c. Thus, the piezoelectric element 30 may be attached to the panel 10 without impairing the degree of freedom of the deformation thereof. Also, the joint member 70c may be a non-heat curable adhesive, which offers an advantage that, during curing, thermal stress shrinkage is hardly generated between the display unit 20 and the piezoelectric element 30 and the panel 10. Or, the joint member 70c may be the double-sided adhesive tape, which offers an advantage that, between the display unit 20 and the piezoelectric element 30 and the panel 10, shrinkage stress, which is caused in using the adhesive, is hardly applied.

According to the present embodiment, also, the panel 10 is attached to the housing 60 by the joint member 70a as the adhesive. Since the joint member 70a is the liquid adhesive or the liquid-like fluid adhesive, the joint member 70a is highly airtight as compared with the double-sided adhesive tape having the spongy base material, and thus a small amount thereof may achieve waterproof (sealing) property and great joint strength of the electronic apparatus 1. Therefore, a disposing area (application area) of the joint member 70a is smaller than that of the double-sided adhesive tape and the like, allowing downsizing of the electronic apparatus 1. Further, since an amount of the joint member 70a necessary for achieving the waterproof property and desired joint strength is smaller than the double-sided tape and the like, material cost may be reduced.

According to the present embodiment, further, the peripheral portion of the region of the panel 10 supporting the piezoelectric element 30 is attached to the housing 60 by the joint member 70b that has lower hardness than the hardness of the joint member 70a after cured. Since the peripheral portion of the overlapping region of the piezoelectric element 30 and the pane 10 in the planar view locates in the vicinity region of the piezoelectric element 30, the vibration of the piezoelectric element 30 is easily delivered thereto. That is, the region of the panel 10, to which the vibration of the piezoelectric element 30 is easily delivered, and the housing 60 are attached together by the joint member 70b. Since the joint member 70b easily deforms (vibrates) as compared with the joint member 70a, the vibration of the piezoelectric element 30 is hardly suppressed and thus a decrease in a sound pressure may be prevented.

### Second Embodiment

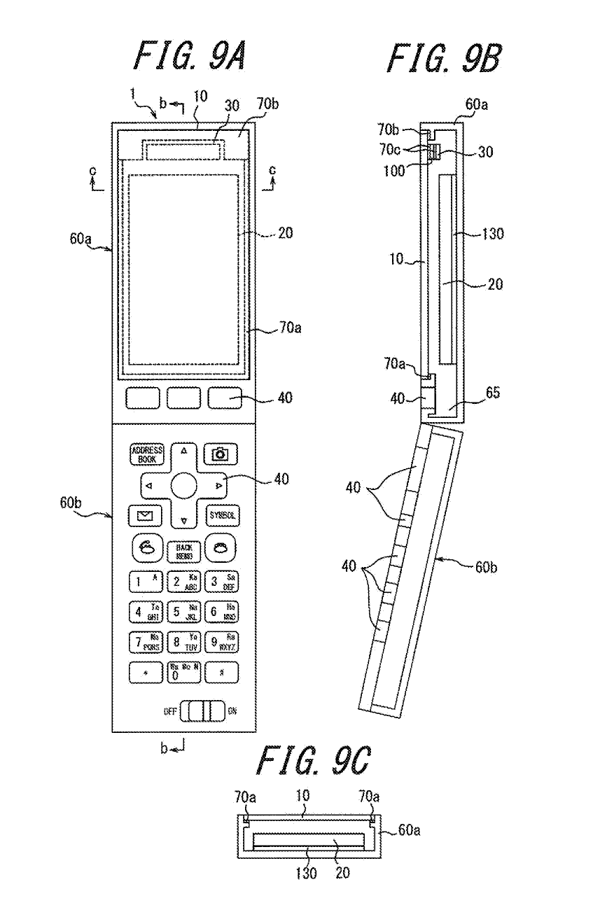

FIG. 9 is a diagram illustrating a housing structure of the electronic apparatus 1 according to a second embodiment. FIG. 9(a) is a front view, and FIG. 9(b) is a cross-sectional view taken from line b-b of FIG. 9(a). FIG. 9(c) is a cross-sectional view taken from line c-c of FIG. 9(a). The electronic apparatus 1 illustrated in FIG. 9 is a folding mobile phone terminal having a cover panel (acryl plate) serving as the panel 10 for supporting the display unit 20 disposed on a front side of an upper housing 60a and the input unit 40 disposed at a lower housing 60b. Note that, for the purpose of clarity of the figure, FIG. 9(c) omits the piezoelectric element 30 and the reinforcing member 100 that are visible inside the housing 60a.

The panel 10 of the second embodiment, in a manner similar to that of the first embodiment, is supported by the housing 60a via the joint member 70a as the adhesive in the first joint region except the peripheral region having the piezoelectric element 30 attached thereto. Also, the panel 10, in the second joint region in the periphery of the attaching region, is supported by the housing 60a via the joint member 70b, which has lower hardness than the joint member 70a. The first joint region of the joint member 70a and the second joint region of the joint member 70b, in a manner similar to the first embodiment, may overlap each other and have outlines in the irregular shapes.

Between the panel 10 and the piezoelectric element 30, the reinforcing member 100 is disposed. The reinforcing member 100 is, for example, a resin plate, a metal plate, or a plate made of resin containing glass fibers. That is, the electronic apparatus 1 according to the second embodiment has a structure in which the piezoelectric element 30 and the reinforcing member 100 are attached to each other by the joint member 70c and, further, the reinforcing member 100 and the panel 10 are attached to each other by the joint member 70c.

According to the second embodiment, further, the display unit 20 is not attached to the panel 10 but is supported by the housing 60a. That is, the electronic apparatus 1 according to the second embodiment has a structure in which the display unit 20 is spaced away from the panel 10 and the display unit 20 and the housing 60a are attached together via a circuit board 130.

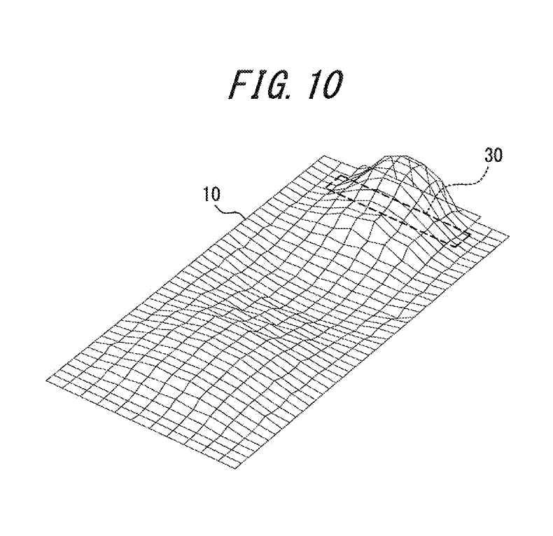

FIG. 10 is a diagram illustrating an example of the vibration of the panel 10 of the electronic apparatus 1 according to the second embodiment. In the electronic apparatus 1 according to the second embodiment, since the panel 10 is an acrylic plate having lower rigidity than that of the glass plate and, also, the display unit 20 is not attached to the rear surface of the panel 10, the vibration generated by the piezoelectric element 30 is larger than that of the electronic apparatus 1 according to the first embodiment illustrated in FIG. 4. Also, the panel 10 vibrates in the attaching region having the piezoelectric element 30 attached thereto, as well as the region remote from the attaching region. Accordingly, the user may hear the air conduction sound via the air and also the vibration sound by bringing any region of the panel 10 into contact with the ear.

According to the electronic apparatus 1 of the present embodiment, as described above, the reinforcing member 100 and the panel 10 deform due to the deformation of the piezoelectric element 30 attached to the panel 10 via the reinforcement member 100, and thus the air conduction sound and the vibration sound are delivered to an object in contact with the panel 10 being deformed. Therefore, the air conduction sound and the vibration sound may be delivered to the user without the necessity for the user to bring the vibrator itself into contact with the ear. Also, since the piezoelectric element 30 is attached to the surface of the panel 10 inside the housing 60a, the air conduction sound and the vibration sound may be delivered to the user without the necessity to protrude the vibrator on the outer surface of the housing 60a. Further, the panel 10 deforms in the attaching region having the piezoelectric element 30 attached thereto as well as any portion thereon so as to deliver the air conduction sound and the vibration sound. Accordingly, the user may hear the air conduction sound via the air and also the vibration sound by bringing any region of the panel 10 into contact with the ear.

According to the present embodiment, also, since the reinforcing member 100 is provided between the piezoelectric element 30 and the panel 10, upon application of external force on the panel 10, the possibility that the external force is delivered to and breaks the piezoelectric element 30 may be reduced. Also, when the panel 10 is strongly pressed against the human body, the vibration of the panel 10 hardly attenuates. Further, since the reinforcing member 100 is provided between the piezoelectric element 30 and the panel 10, a resonance frequency of the panel 10 is reduced and acoustic characteristics of a low frequency band are improved. Note that, in place of the reinforcing member 100, a plate-shaped weight may be attached to the piezoelectric element 30 by the joint member 70c.

According to the present embodiment, also, the panel 10 is attached to the housing 60a by the joint member 70a as the adhesive. Since the joint member 70a is the liquid adhesive or the liquid-like fluid adhesive, the joint member 70a is highly airtight as compared with the double-sided adhesive tape and the like having the spongy base material, and thus a small amount thereof may achieve the waterproof property and great joint strength of the electronic apparatus 1. Since an amount of the joint member 70a to be used is smaller than an amount of the double-sided tape and the like, size reduction and the material cost of the electronic apparatus 1 may be achieved.

According to the present embodiment, further, the periphery of the region of the panel 10 supporting the piezoelectric element 30 is attached to the housing 60a by the joint member 70b having a lower hardness than that of the joint member 70a after curing. Since the joint element 70a that is deformable is used in the region of the panel 10 to which the vibration from the piezoelectric element 30 is easily delivered, the vibration of the piezoelectric element 30 is hardly suppressed, preventing a decrease in sound pressure.

Although the present invention has been described based on the figures and the embodiments, it is to be understood that various modifications and changes may be implemented based on the present disclosure by those who are ordinarily skilled in the art. Accordingly, such modifications and changes are included in a scope of the present invention. For example, functions and the like included in each member, each step and the like may be rearranged without logical inconsistency, so as to combine a plurality of components or steps together or to divide them.

For example, when the electronic apparatus 1 has a structure in which the panel 10 and the display unit 20 do not overlap each other, the piezoelectric element 30 may be disposed in a center of the panel 10. When the piezoelectric element 30 is disposed in the center of the panel 10, the vibration of the piezoelectric element 30 is delivered equally to the entire panel 10, whereby quality of the air conduction sound may be improved and the user may recognize the vibration sound by bringing various regions of the panel 10 into contact with the ear. In this case also, in the region in the vicinity of the region of the panel 10 attached to the piezoelectric element 30, the panel 10 and the housing 60 (60a) are attached together by the joint member 70b while, in other regions, the panel 10 and the housing 60 (60a) are attached together by the joint member 70a. Note that any number of the piezoelectric elements 30 may be attached.

Also, although in the electronic apparatus 1 described above the piezoelectric element 30 is attached to the panel 10, the piezoelectric element 30 may be attached elsewhere. According to the first embodiment, for example, the piezoelectric element 30 may be attached to a battery lid attached to the housing 60 for covering a battery. In the electronic apparatus 1 such as the mobile phone terminal and the like, since the battery lid is often attached to a plane different from a plane having the panel 10, such configuration allows the user to hear the sound by bringing a surface other than the panel 10 into contact with a part of the body (for example, the ear).

Further, the panel 10 may form any one of, or all of a display panel, an operation panel, the cover panel, a lid panel for mounting/removing the battery. Especially, when the panel 10 constitutes the display panel, the piezoelectric element 30 is disposed outside a display area for serving a display function. This offers an advantage that a display is hardly inhibited. The operation panel includes the touch panel of the first embodiment. The operation panel also includes a sheet key, which is a member having key tops of operation keys integrally formed on the folding mobile phone terminal and constitutes one plane of the housing on an operation unit side.

According to the present embodiments, the hardness may be measured in conformity with international rubber hardness (IRHD-M method) such as, for example, JIS K 6253 and ISO 48. Also, as a measuring device, IRHD-M-method micro-size international rubber hardness measurer GS680 of a fully automatic type produced by Teclock Cooperation is preferably used.

### REFERENCE SIGNS LIST

1 electronic apparatus
5 radio communication unit
10 panel
20 display unit
30 piezoelectric element
40 input unit
41 mouthpiece
50 control unit
60, 60a, 60b housing
70a joint member (first joint member)
70b joint member (second joint member)
70c joint member (third joint member)
80a, 80b, 80c, 80d overlapping region
90, 90a, 90b, 95 irregular shape
100 reinforcing member
130 circuit board

1. An electronic apparatus comprising a housing and a panel supported by the housing, wherein the panel vibrates generating a vibration sound to be delivered by vibrating a part of a human body, and
the panel includes a first joint region attached to the housing by a first joint member as an adhesive.

2. The electronic apparatus according to claim 1, comprising a piezoelectric element supported by the panel.

3. The electronic apparatus according to claim 2, including a second joint region where a peripheral portion of a region of the panel supporting the piezoelectric element is attached to the housing by a second joint member having lower hardness than that of the adhesive.

4. The electronic apparatus according to claim 3, wherein the second joint member is a double-sided adhesive tape.

5. The electronic apparatus according to claim 3, wherein a portion of the first joint region and a portion of the second joint region overlap each other.

6. The electronic apparatus according to claim 5, wherein an outline of the portion of the first joint region has an irregular shape in a planar view of the panel.

7. The electronic apparatus according to claim 5, wherein an outline of the portion of the second joint region has an irregular shape in the planar view.

8. The electronic apparatus according to claim 7, wherein the outline of the portion of the first joint region has an irregular shape corresponding to the irregular shape of the second joint region.

9. The electronic apparatus according to claim 1, wherein the adhesive has elasticity.

10. The electronic apparatus according to claim 1, wherein the housing has a rectangular shape in a planar view with two sides opposite to each other equal to or longer than a distance from the antitragus to the inferior antihelix crus.

11. The electronic apparatus according to claim 10, wherein the housing has the other two sides opposite to each other equal to or longer than a distance from the tragus to the antihelix.

12. The electronic apparatus according to claim 1, wherein the piezoelectric element is fixed to the housing by a third joint member.

13. The electronic apparatus according to claim 12, wherein the third joint member is a non-heat curable adhesive.

14. The electronic apparatus according to claim 12, wherein the third joint member is the double-sided adhesive tape.

15. The electronic apparatus according to claim 1, wherein the panel constitutes any one of, or all of a display unit, an input unit, and a cover of the display unit.

16. The electronic apparatus according to claim 15, wherein an attaching region of the panel having the piezoelectric element fixed thereto is located outside a region of the panel overlapping the display unit in a planer view.

17. The electronic apparatus according to claim 15, wherein the display unit is fixed to the panel from the inside of the housing.

18. The electronic apparatus according to claim 1, wherein the panel generates an air conduction sound.
